(19) United States
(12) Patent Application Publication
(10) Pub. No.: US 2015/0234042 A1
(43) Pub. Date: Aug. 20, 2015

(54) DEVICE AND METHOD FOR DETECTING AN AXLE OF A VEHICLE

(71) Applicant: Kapsch TrafficCom AG, Vienna (AT)

(72) Inventor: Oliver Nagy, Wien (AT)

(21) Appl. No.: 14/612,041

(22) Filed: Feb. 2, 2015

(30) Foreign Application Priority Data
Feb. 19, 2014 (EP) 14155688.6

(51) Int. Cl. G01S 13/58; G01S 7/02; G01S 13/86

(52) U.S. Cl. CPC G01S 13/58; G01S 13/867; G01S 7/02

(57) ABSTRACT

The present disclosed subject matter relates to a device and a method for detecting an axle of a vehicle travelling on a road. The device includes a plurality of radar sensors, which each, by means of an approximately vertically downwardly directed measuring beam of the transceiver thereof, at successive moments in time generate a Doppler speed measurement value for an object reflecting the measuring beam, and an evaluation unit, which is connected to measurement value outputs of the radar sensors and which is configured to detect an axle when two radar sensors, within a tolerance time window, generate maxima or minima of the speed measurement values thereof, said maxima or minima being of substantially identical size.

### CROSS-REFERENCE TO RELATED APPLICATION(S)

This application claims priority to European Patent Application No. 14 155 688.6, titled “Device and Method for Detecting an Axle of a Vehicle,” filed on Feb. 19, 2014, the entirety of which is incorporated by reference herein.

### BACKGROUND

1. Technical Field

The present subject matter relates to a device and a method for detecting an axle of a vehicle travelling on a road.

2. Background Art

For axle detection for a travelling vehicle, induction loops are nowadays installed in the road or foundation thereof and can detect an axle on the basis of the magnetic conductivity in particular of the metal wheel rim as the vehicle travels over the induction loops. Sensors of this type, however, require complex structural measures to be taken at the road in the case of installation, maintenance or exchange. In addition, dirt or road damage, for example by frost, leads to interference or false signals in the vicinity of such sensors.

Alternatively, individual wheels of a vehicle are located by means of suitable evaluation algorithms on the basis of their shape in a recorded image of a vehicle side or a 3D model produced by laser scanning of the vehicle side, for example in accordance with patent application US 2002/0140924 A1, and from this the presence of axles is indicated. Here, however, any approximately circular structure on the vehicle, for example a hose drum or, in the case of recorded images, even representations such as advertising lettering, hinders the correct evaluation; laser scanning and 3D model creation are also very complex methods. In addition, optical methods of this type are susceptible to obstructions in the field of vision, for example caused by spray or snowfall and soiling of the measurement optics. Furthermore, a detection of an individual wheel mounted on one side does not provide a reliable indication of a vehicle axle; it could also be a laterally mounted spare wheel or a raised axle of the vehicle, not usually to be taken into consideration.

It is also known to detect wheels of a vehicle travelling on a road using a radar sensor mounted on the road or in a measuring vehicle, see patent EP 2 538 239 B1 or patent application WO 2012/175470 A1 in the name of applicant. Here, a wheel is detected by suitable alignment of the radar sensor with the vehicle side and bundling of the measuring beam of said sensor approximately at the height of the axle in the frequency spectrum of the reflected radar measuring beam as a result of the rotation of the wheel and the resultant Doppler frequency shift of the reflected measuring beam. Here, the radar sensor is aligned individually with the vehicle and wheel thereof, to which end the distance of the vehicle passing by from the radar sensor is determined in advance.

As is described in detail in the aforementioned document WO 2012/175470 A1, a planar region in which the measuring beam contacts the vehicle or wheel results in different Doppler frequency shifts and therefore in a “splitting” or “spreading” of the frequency of the measuring beam and therefore in a receiving frequency mixture, on the basis of which wheels can be detected with high accuracy.

However, in the case of the specified optical and radar-based method, the correct positioning of the camera, scanner or radar sensors is difficult, and overlaps by other vehicles are virtually impossible to prevent particularly in the case of roads over which vehicles travel in a number of lanes.

### BRIEF SUMMARY

The object of the disclosed subject matter is to create a device and a method for detecting an axle of a vehicle travelling on a road, said device and method ensuring a high accuracy of the axle detection with manageable measuring effort and also being usable on multi-lane roads and being insensitive to weather.

This object is achieved in accordance with a first aspect of the disclosed subject matter with a device for detecting an axle of a vehicle travelling on a road, said device comprising:

a plurality of radar sensors, which have transceivers distributed on a supporting structure transversely above the road and which each, by means of an approximately vertically downwardly directed measuring beam of the transceiver thereof, generate at successive moments in time a Doppler speed measurement value for an object reflecting the measuring beam, and

an evaluation unit, which is connected to measurement value outputs of the radar sensors and which is configured to detect an axle when two radar sensors, within a tolerance time window, generate substantially equal maxima, or instead minima, of the speed measurement values thereof.

Due to the use of radar sensors, interference with the detection results due to weather-induced visual impairment or soiling is considerably reduced. The overhead arrangement of the radar sensors and the effect thereof approximately vertically downwardly enables the use of the device on multi-lane roads, more specifically in the same way and with identical accuracy for all lanes, without the need here for ongoing individual alignment of the radar sensors or transceivers thereof with individual vehicles or wheels. Since an axle is identified by double detection, that is to say by detection of a wheel on each side of the vehicle, said wheels rotating at the same speed, the device according to the disclosed subject matter has a much higher accuracy in the case of the detection of axles than previous detectors. Raised axles of a vehicle or objects mounted thereon on one side do not falsify the result.

Due to the Doppler measurement substantially from above, only the vertical tangential component of the rotation of a wheel is detected, but not the speed of the moved object (vehicle) itself. This decoupling of the vertical tangential component of the wheel rotation and the movement of the measurement object leads to much more robust detection results.

In order to attain an improved differentiation from one another of vehicles travelling side by side, the evaluation unit, may, for example, be designed to detect only one axle if all radar sensors arranged between the aforementioned two radar sensors at the same time generate speed measurement values falling below a threshold value. For axle detection, the Doppler speed measurement values of those radar sensors that are arranged just outside the respective lateral extension of the vehicle, thereabove, and thus provide the measurement signal with the strongest amplitude are thus utilised, therefore increasing the measurement accuracy. A low “noise” of the measured speed values of the intermediate radar sensors has no interfering influences.

In an embodiment, the device according to the disclosed subject matter further comprises a plurality of propagation time sensors, which have propagation time transceivers distributed on the supporting structure transversely above the road and which each, by means of an approximately vertically downwardly directed propagation time measuring beam of the propagation time transceiver thereof, generate at successive moments in time a propagation time distance measurement value for an object reflecting the propagation time measuring beam, wherein the evaluation unit is also connected to measurement value outputs of the propagation time sensors and is configured to only detect an axle if all propagation time sensors arranged between the two aforementioned radar sensors at the same time generate a distance measurement value corresponding to less than the height of said propagation time sensors above the empty road.

In an alternative or also combinable embodiment, the device according to the disclosed subject matter comprises a plurality of propagation time sensors each assigned a dedicated radar sensor, said propagation time sensors having propagation time transceivers distributed on the supporting structure transversely above the road and each generating, by means of an approximately vertically downwardly directed propagation time measuring beam of the propagation time transceiver thereof, at successive moments in time a propagation time distance measurement value for an object reflecting the propagation time measuring beam, wherein the evaluation unit is connected to measurement value outputs of the propagation time sensors and is configured to only detect an axle if the propagation time sensors assigned to the two aforementioned radar sensors at the same time generate a distance measurement value corresponding to the height of said propagation time sensors above the empty road.

The additional use of the distance measurement values increases the accuracy of the axle detection, since a vehicle structure detected between two detected wheels reliably avoids a false detection in the case of two vehicles travelling side by side at the same speed, and/or it is ensured that generated speed measurement values actually originate from wheels resting on the road and not, for example, from other vehicles or vehicles bodies. The assignment of detected wheels to a vehicle is also facilitated, even when said vehicle changes lanes. If desired, the detected axles can also be assigned to individual vehicles on the basis of a vehicle height established by the propagation time distance measurement performed at the same time, and the total axle number of the vehicles can thus also be determined and/or examined, for example for plausibility.

For example, laser sensors or other known propagation time sensors can be used as propagation time sensors. The propagation time sensors (Rₙ) may, for example, be formed by the radar sensors (Rₙ). Mounting and connection of additional sensors is thus omitted; propagation time distance measurement values and speed measurement values, if desired, can also be produced simultaneously on the basis of the same radar/propagation time measuring beam.

The measuring beam may be modulated or unmodulated, wherein only in the case of a modulated measuring beam is the simultaneous evaluation of propagation time and Doppler shift possible. Modulated measuring beams may therefore be used, wherein all known modulation methods can be used, such as amplitude-modulated pulse methods with propagation time measurement of the individual pulses. This method is further improved by utilisation of what are known as “chirps”, wherein the impulse itself is frequency-modulated. A further particularly suitable form of the modulated method is the use of (non amplitude-modulated) frequency-modulated measuring beams, for example with continuous (continuous-wave) measuring beams, known as the FMCW method (frequency modulation—continuous wave). Here, the measuring signal is modulated with constant amplitude, for example triangularly (frequency shift keying, FSK) or in a sawtooth-shaped manner (stepped-frequency continuous wave, SFCW). Phase-coded or noise-modulated continuous-wave radar sensors can also be used.

The radar sensors are, for example, frequency-modulated continuous-wave radar sensors, which allow the simultaneous measurement of propagation time and speed. If desired, time resolution and thus spatial resolution can also be adapted in relation to the passing vehicle, for example depending on traffic. The measuring beams, may, for example, be frequency-modulated triangularly here. Due to the triangle shape, the separation of a propagation time distance measurement value from a Doppler speed measurement value is particularly simple; the attainable resolution of the measurement values increases with the frequency change rate.

In order to further increase the detection reliability, the arrangement of the transceivers of the radar sensors and the beam width of the measuring beams may, for example, be matched to one another, such that the measuring beams have a beam width

$$α \geq 2 \cdot arc tan \frac{d}{e - {r}_{max}}$$

where:

d . . . distance between adjacent transceivers;

e . . . height of the transceivers above the empty road;

rₘₐₓ . . . radius of the largest possible wheel of an axle to be detected.

This leads to a selective overlap of the measuring beams in the measuring range below the supporting structure, such that at least one radar sensor on each vehicle side detects a wheel, more specifically independently of vehicle width and position of the vehicle in the transverse direction of the road. The mutual overlap of the measuring beams can be selectively controlled by suitable matching with one another of the specified parameters.

In order to attain a suitable beam width angle of the measuring sensors with simultaneously small and compact design, measuring frequencies in the range from 1 to 100 GHz, but particularly in the range above 50 GHz, are suitable.

The device according to the disclosed subject matter can also be used to determine further parameters. For example, the evaluation unit may be configured to determine the width of the vehicle from the distance between the aforementioned two radar sensors. Besides the axle detection, the width thus determined of the vehicle (possibly in combination with the height, also determined, of the vehicle) can be used for example for classification of vehicles.

The evaluation unit may, for example, be configured to establish the orientation of a vehicle on the road from a speed of said vehicle established from the maxima or minima, from the interval between the two maxima or minima in the aforementioned tolerance time window, and from the established width of said vehicle. The vehicle orientation can thus be established from the inclined position of a detected axle relative to the road longitudinal direction or the device, and for example a lane change or a swerve can be identified. Thus, the evaluation unit may, for example, be configured to establish the position of the vehicle in the transverse direction of the road from the position of the two aforementioned radar sensors on the supporting structure. The position of the vehicle in the transverse direction of the road thus determined can be used for example to identify the lane selected by the vehicle.

So as to be able to determine the vehicle movement on the road, the evaluation unit may, for example, also be configured to estimate a trajectory of the vehicle on the road from the established orientation, the established position and the established speed of the vehicle.

In an embodiment of the disclosed subject matter, the device according to the disclosed subject matter further comprises a first camera, which is directed onto a first road portion upstream of the device and provides first recorded images to the evaluation unit, and a second camera, which is directed onto a second road portion downstream of the device and provides second recorded images to the evaluation unit, wherein the evaluation unit is configured, on the basis of the estimated trajectory of a vehicle, to assign a first recorded image of the vehicle taken from the front to a second recorded image of the same vehicle taken from the rear.

The recorded images assigned to one another can be further processed arbitrarily, for example stored for purposes of proof and/or forwarded on and have a high probative value on account of their dual view. For example a vehicle identification can thus be assisted, wherein a vehicle registration number can be read from the two recorded images and these two registration numbers can be evaluated and checked for a match. A rejection of non-matching recorded images or vehicle registration numbers, which is often necessary in the case of traffic monitoring measures, can thus be omitted in the case of automatic evaluation or manual re-working.

In some countries (for example in Australia), a vehicle is by contrast provided with just a single vehicle registration number plate, which the vehicle owner can mount on the vehicle front or vehicle rear. An assignment of the two recorded images of the same vehicle taken from the front and rear here enables the reliable detection and identification of any vehicle.

In a further embodiment of the disclosed subject matter, the device comprises at least one camera, which is directed onto a road portion upstream or downstream of the device and which provides recorded images to the evaluation unit, and a radio transceiver, for example in accordance with the RFID, (CEN or UNI) DSRC, ITS-G5 or IEEE WAVE 802.11p standard, which, in order to read identifying data from a vehicle device carried by a passing vehicle, is directed onto the road or lane and provides the read-out identifying data to the evaluation unit, wherein the evaluation unit is configured to assign a recorded image of the vehicle to the read-out identifying data of the vehicle device of the same vehicle on the basis of the estimated trajectory of a vehicle.

Here, the identifying data may be a clear identification of the vehicle device and/or vehicle-specific data, for example vehicle dimensions, axle number, etc. The vehicle device and therefore the vehicle owner can be identified on the basis of this identifying data, or the identifying data can be used in order to identify offences, for example an axle number of a vehicle declared too low by the operator of the vehicle device, wherein the assigned recorded image is stored or forwarded on for purposes of proof.

In a second aspect, the disclosed subject matter creates a method for detecting a wheel axle of a vehicle travelling on a road with the aid of a plurality of radar sensors, which have transceivers distributed on a supporting structure transversely above the road and which each, by means of an approximately vertically downwardly directed measuring beam of the transceiver thereof, at successive moments in time generate a Doppler speed measurement value for an object reflecting the measuring beam, said method comprising the following steps:

detecting a wheel axle when two radar sensors, within a tolerance time window, generate maxima or minima of the speed measurement values thereof, said maxima or minima being of identical size and exceeding a first threshold value.

With regard to the advantages and further embodiments of the method according to the disclosed subject matter, reference is made to the previous statements concerning the device.

### BRIEF DESCRIPTION OF THE DRAWINGS/FIGURES

The disclosed subject matter will be explained in greater detail hereinafter on the basis of exemplary embodiments illustrated in the accompanying drawings. In the figures:

FIGS. 1 and 2 show a schematic side view (FIG. 1) and rear view (FIG. 2) of vehicles travelling on a road as said vehicles pass the device according to an embodiment.

FIG. 3 shows a block diagram of the device of the disclosed subject matter.

FIG. 4 shows a schematic and partial plan view of the device of the disclosed subject matter in conjunction with exemplary measurement value progressions of the radar sensors of the device as a vehicle passes.

FIG. 5 shows, in plan view, a vehicle as said vehicle changes lanes whilst it passes the device of the disclosed subject matter, in conjunction with exemplary measurement value progressions of two radar sensors and recorded images of cameras of the device.

### DETAILED DESCRIPTION

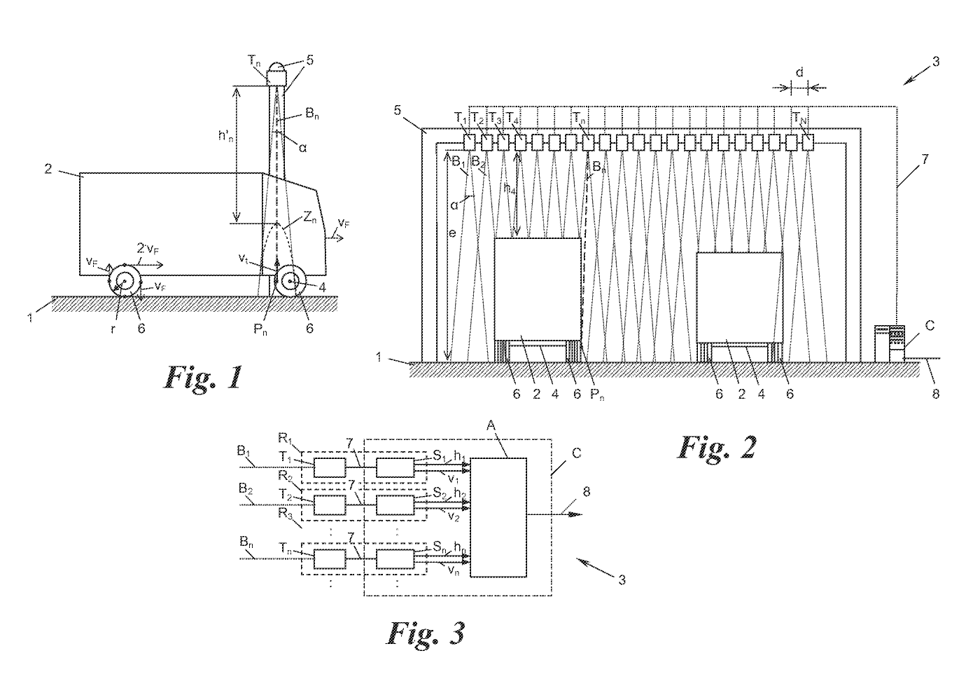

According to FIGS. 1 to 5, vehicles 2 travelling on a road 1 pass a device 3 for detecting axles 4 of the vehicles 2. The device 3 comprises a plurality of radar sensors R₁, R₂, . . . , R_{N}, generally which have radar transceivers T₁, T₂, . . . , T_{N}, generally Tₙ, distributed on a supporting structure 5 transversely above the road 1, that is to say above the road 1 and distanced therefrom. The transceivers Tₙ each transmit an approximately vertically downwardly directed radar measuring beam B₁, B₂, . . . , B_{N}, generally Bₙ, with known temporal frequency profile and/or impulse profile. Each measuring beam Bₙ is reflected from a contact point P₁, P₂, . . . , P_{N}, generally Pₙ, on an object (here the road 1, the vehicle 2 or wheel 6 thereof) and is also received again by the respective transmitting transceiver Tₙ.

The radar sensors Rₙ or transceivers Tₙ thereof can irradiate pulsed measuring beams Bₙ, and also pulse-coded measuring beams when desired in order to avoid mutual interference; they may alternatively also be modulated continuous-wave radar sensors Rₙ for example frequency-modulated continuous-wave radar sensors Rₙ. The measuring beams Bₙ may, for example, be triangularly frequency-modulated and have a frequency change rate of more than 10 MHz/μs, for example, more than 50 MHz/μs. Here, the transceivers Tₙ, which are arranged adjacently to the supporting structure 5 or closely to one another, are operated in multiplex in order to avoid mutual interference, more specifically in code multiplex, time multiplex or frequency multiplex.

As is illustrated in FIGS. 1, 2, 4 and 5, the measuring beams Bₙ, in spite of bundling by suitable antenna design, never have an ideal punctiform cross section, and the contact points Pₙ thus are not punctiform, but always expanded to planar contact regions Zₙ. Hereinafter, the principle of action of the radar sensors Rₙ will be explained initially on the basis of an idealised punctiform cross section of the measuring beams Bₙ, before the divergence of the measuring beams Bₙ occurring in reality and the resultant differences from the ideal case are discussed on the basis of the exemplary embodiments.

If the reflecting object 1, 2, 6 at the contact point Pₙ of the measuring beam Bₙ has a speed component in the direction of radiation relative to the transceiver Tₙ, that is to say away from the transceiver Tₙ or theretoward, the measuring beam Bₙ is thus reflected in a frequency-shifted manner on account of the Doppler effect, and a radar measuring unit S₁, S₂, . . . , S_{N}, generally Sₙ, of the respective radar sensor Rₙ generates a speed measurement value v₁, v₂, . . . , v_{N}, generally vₙ, on the basis of the difference between the known transmitting frequency and the measured receiving frequency.

Furthermore, the device 3 may comprise a plurality of propagation time sensors Rₙ with propagation time measuring units Sₙ and propagation time transceivers Tₙ (not illustrated separately in FIGS. 1 to 5) distributed on the supporting structure 5 transversely above the road 1, wherein the propagation time sensors Rₙ each generate, by means of an approximately vertically downwardly directed propagation time measuring beam Bₙ of the propagation time transceiver Tₙ thereof, at successive moments in time a propagation time distance measurement value h₁, h₂, . . . h_{N}, generally hₙ, for an object 1, 2, 6 reflecting the propagation time measuring beam Bₙ, that is to say from the propagation time of the propagation time measuring beam Bₙ from the transceiver Tₙ to the object 1, 2, 6 and back to the transceiver Tₙ.

Here, the propagation time sensors Rₙ may be sensors separate from the radar sensors Rₙ, for example laser propagation time sensors, wherein, if desired, a propagation time sensor Rₙ is assigned to each radar sensor Rₙ and a propagation time transceiver Tₙ is assigned to each radar transceiver Tₙ in the immediate vicinity thereof on the supporting structure 5, or the propagation time sensors Rₙ are, for example, formed by the radar sensors Rₙ themselves, which is why in the present embodiments the term “radar sensors Rₙ” is generally understood hereinafter to mean sensors both for propagation time distance measurement and for Doppler speed measurement unless explicitly specified otherwise.

The measuring unit Sₙ and transceiver Tₙ of a radar sensor (and therefore also propagation time sensor) Rₙ can be integrated and arranged commonly on the supporting structure 5, or, as is illustrated in the example of FIG. 3, merely the transceiver Tₙ may be arranged on the supporting structure 5, and the measuring units Sₙ are housed commonly with an evaluation unit A of the device 3 in a computing unit C, arranged for example at the roadside, and are connected to the transceivers Tₙ. Here, the measuring units Sₙ as well as the evaluation unit A, can be implemented as individual, separate hardware modules or as software modules or as a mixture thereof in the computing unit C. The computing unit C can also be distributed over a plurality of components distanced from one another. The computing unit C and the radar sensors Rₙ arranged on the supporting structure 5, or, in the example of FIG. 3, the transceivers Tₙ thereof, are interconnected via data connections 7.

An axle detection is shown in FIG. 1 for a vehicle 2 passing at the speed v_{F} on the road 1, said vehicle corresponding for example to the left-hand vehicle 2 of FIG. 2. Here, the measuring beam Bₙ has a contact point Pₙ on the front wheel 6 of the vehicle 2. At this point Pₙ the wheel 6 has a tangential speed vₜ in relation to the transceiver Tₙ. The resultant Doppler frequency shift of the measuring beam Bₙ, which is proportional to the aforementioned tangential speed, allows the radar sensor Rₙ to generate a speed measurement value vₙ for the contact point Pₙ on the wheel 6. The radar sensor Rₙ then provides its generated speed measurement values vₙ (and where applicable distance measurement values hₙ) to the connected evaluation unit A via the measurement value outputs thereof (FIG. 3).

As outlined briefly further above, in the case precisely of radar sensors Rₙ, the measuring beams Bₙ in reality diverge even with bundling by suitable antennas and selection of the measuring frequencies, for example in the range from 1 to 100 GHz, in particular more than 50 GHz, and thus have a beam expansion illustrated in FIGS. 1 and 2 as the beam width α in the case of irradiation from the transceiver Tₙ. A “splitting” or “spreading” both with respect to the propagation time of a measuring beam Bₙ and also with respect to the Doppler frequency shifts thus results. In the example of FIG. 2, this means that the radar sensor R₁ with the transceiver T₁ can still relatively precisely determine the mounting height e above the “empty” road 1 as distance measurement value h₁, and the radar sensor R₄ with the transceiver T₄ can still relatively precisely determine the height of the roof of the vehicle 2 above the road 1 as distance measurement value h₄ in spite of beam spreading; by contrast, the radar sensor Rₙ with its transceiver Tₙ according to FIGS. 1 and 2 has an expanded contact region Zₙ due to the beam width α of the measuring beam Bₙ of said radar sensor, the contact region lying partially on the side face of the vehicle 2, partially on the front wheel 6 thereof and partially on the road 1. The propagation time measured in the radar sensor Rₙ in this case lies between that to the empty road 1 and the distance h′ₙ of the highest point of the contact region Zₙ on the side face of the vehicle 2.

The measuring unit Sₙ of the radar sensor Rₙ consequently generates a mean value as distance measurement value hₙ, said mean value optionally being additionally weighted with the aid of further parameters, for example the course of time or the amplitudes of various components of the reflected measuring beam Bₙ etc. Alternatively, the radar sensor Rₙ, if desired, could also generate a distance measurement value hₙ corresponding to the minimal or maximum propagation time or could generate as distance measurement value hₙ the entire “spread” measurement value range, that is to say the range from the minimum to maximum distance detected at a moment in time.

The same is true for the generation of the Doppler speed measurement value vₙ, since the measuring beam Bₙ is reflected depending on the beam width α by a not insignificant region of the wheel 6, in which an entire bandwidth of various tangential speed components occurs, and the various Doppler frequency shifts thus lead to a “receiving frequency mixture”. The radar sensor Rₙ forms the Doppler speed measurement value vₙ thereof consequently again as a mean value (possibly weighted) directly from the highest (or lowest) measured Doppler frequency shift, optionally with elimination of unplausibly high (low) frequency shifts for example with averaging over time, or as an entire spread measurement value range. An accurate analysis of the shape and progression over time of the receiving frequency mixture as a result of frequency spread can be deduced from patent application WO 2012/175470 A1 in the name of the applicant.

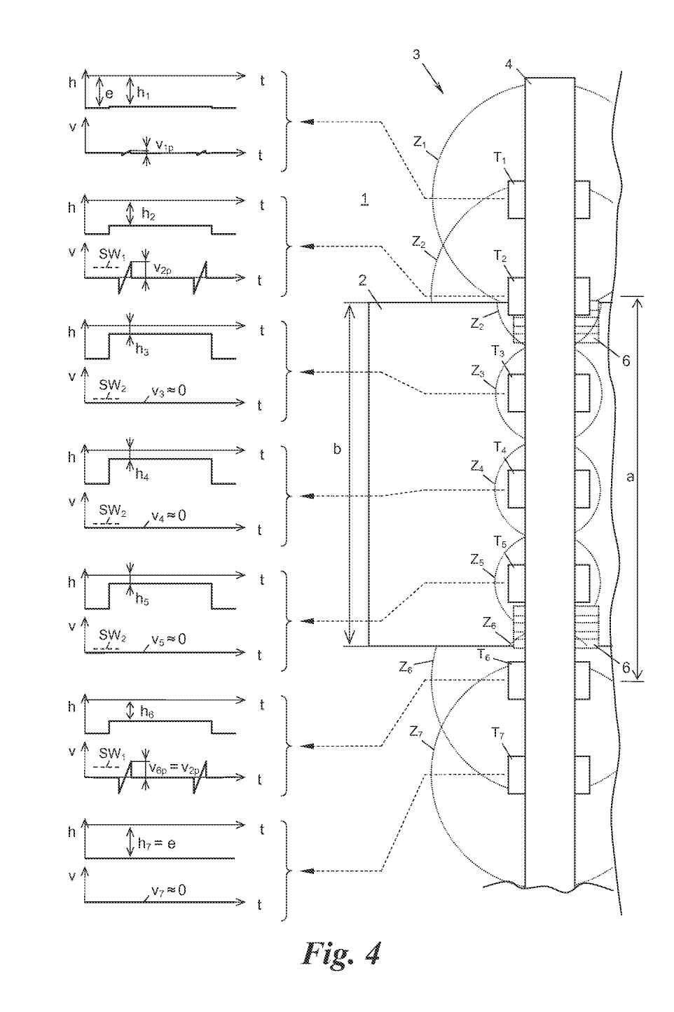

Hereinafter, the method for axle protection performed by the device 3 will be explained in greater detail on the basis of the example illustrated in FIG. 4 for the progression over time of possible distance measurement values hₙ and speed measurement values vₙ of a plurality of adjacent radar sensors Rₙ as a vehicle 2 passes the device 3.

The measuring beam B₁ of the transceiver T₁ has a contact region Z₁, which lies largely on the empty road 1. A small proportion of the contact region Z₁, however, also lies on the vehicle 2 or wheel 6 thereof. The radar sensor R₁ in this example thus provides a (averaged) distance measurement value h₁, hardly differing from the height e above the empty road 1, and also very low maxima (or minima) v_{1,p} of the speed measurement value v₁ for the duration of the passing of the vehicle.

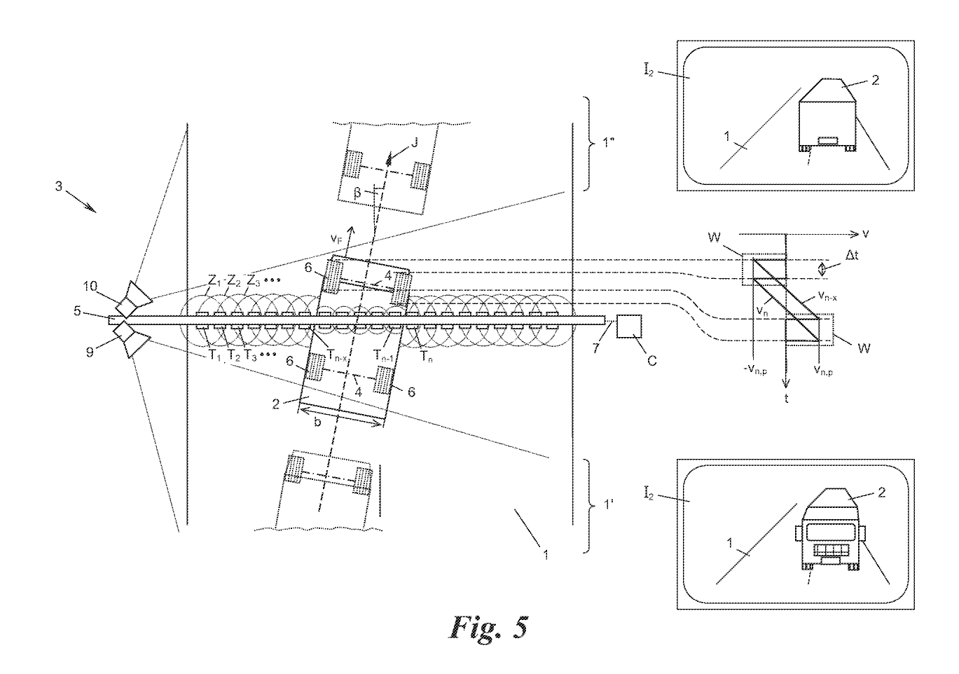

The measuring beams B₂, B₆ of the transceivers T₂, T₆ also contact the empty road 1 in part and the vehicle 2 or left/right wheel 6 thereof in part. Due to these contact regions Z₂, Z₆, the two associated radar sensors R₂, R₆ each deliver (averaged) distance measurement values h₂, h₆, which indicate an object closer than the empty road 1, and also approximately at the same time, or at least within a tolerance time window W (FIG. 5), maxima (or minima) v_{2,p}, v_{6,p} of the speed measurement values v₂, v₆ thereof, said maxima or minima being of substantially identical size and exceeding a first threshold value SW₁, more specifically because the wheels 6 of an axle 4 rotate at substantially the same speed. At the same time, all radar sensors R₃, R₄, R₅ arranged between these two radar sensors R₂, R₆ provide lower distance measurement values h₃, h₄, h₅ than those to the empty road 1, which indicates a vehicle 2 between the two wheels 6 of an axle 4 thus detected.

The evaluation unit A now detects an axle 4 when two radar sensors (here: R₂, R₆) generate, at the same time or within a tolerance time window W, maxima (here: v_{2,p}, v_{6,p}) or minima of the speed measurement values vₙ thereof, said maxima or minima being of substantially identical size. The evaluation unit A then transmits information concerning the axle 4 thus detected via a communications connection 8, wired or via radio, to a remote central unit, for example a vehicle monitoring or toll system.

In the exemplary embodiment of FIG. 4, the maxima (or minima) v_{1,p} of the speed measurement value v₁ of the radar sensor R₁ are eliminated and are not used further for the axle detection by evaluation unit A, more specifically due to the operationally additional detection criterion that precisely those two radar sensors R₂, R₆ are considered between which all intermediate radar sensors R₃, R₄, R₅ generate speed measurement values v₃, v₄, v₅ below a second threshold value SW₂. Alternatively, the evaluation unit A could already leave out of consideration excessively low speed measurement values vₙ, such as those of the radar sensor R₁.

Furthermore, it is possible for the evaluation unit A to detect an axle 4 only in the case when all propagation time or radar sensors (here: R₃, R₄, R₅) arranged between the two aforementioned radar sensors (here: R₂, R₆) generate at the same time a distance measurement value hₙ corresponding to less than the height e of said radar sensors above the road 1.

Alternatively or additionally, the evaluation unit A could also only detect an axle 4 under the precondition that the two aforementioned radar sensors (here: R₂, R₆) or the propagation time sensors assigned thereto generate at the same time a distance measurement value (here: h₂, h₆) corresponding to the height e of said radar sensors above the empty road 1. In this case, should the radar and propagation time sensors Rₙ be formed separately from one another, a propagation time sensor with its transceiver is assigned to each radar sensor Rₙ and transceiver Tₙ thereof, said propagation time sensor being arranged in the physical vicinity of the radar transceiver Tₙ on the supporting structure 5. The correlation of propagation time distance measurement and Doppler speed measurement is thus ensured and is always preserved in the case of identity of propagation time and radar sensor Rₙ. Furthermore, in this case, each propagation time sensor Rₙ generates, as distance measurement value hₙ, either the value corresponding to the maximum established propagation time (according to the example of FIG. 4 where the contact regions Z₂, Z₆ each lie on both on the vehicle 2 and wheels 6 thereof and also on the empty road 1; for the radar sensors R₂, R₆: the height e above the road 1) or a distance range, which (here for the radar sensors R₂, R₆) also includes the height e above the empty road 1, that is to say corresponds thereto (also).

If desired, the evaluation unit A can additionally establish the width b of the vehicle 2 from the mutual distance a between the aforementioned two radar sensors R₂, R₆ or transceivers T₂, T₆ thereof. Here, they could also take into account the distance measurement values h₂, h₆ (averaged here and alternatively also produced as ranges) of the aforementioned two radar sensors R₂, R₆ and could compare these by way of example to the distance measurement values h₃, h₄, h₅ of the intermediate radar sensors R₃, R₄, R₅ in order to increase the accuracy.

Furthermore, the evaluation unit A could carry out further analyses locally (for example assign a plurality of successive axle detections to a vehicle) and ultimately transmit an overall result of the axle detection (for example a vehicle classification) to the central unit. Here, the evaluation unit could also detect offences, for example an inadmissibly high number of vehicle axles, and could only transfer analysis results to the central unit in the case of a detected offence.

As illustrated at the rear wheel 6 of the vehicle 2 in FIG. 1, the maximum tangential speeds vₜ in relation to a transceiver Tₙ arranged vertically thereabove, from which the aforementioned maxima (or minima) v_{n,p} of the speed measurement values vₙ are also generated, occur at the foremost or rearmost point of the wheel 6, as considered in the direction of travel, precisely at the height of axis of rotation 4 thereof, that is to say at the height of the radius r thereof above the road 1. Since a maximum v_{n,p} and a minimum occur per wheel 6 and are of identical magnitude, it is suffice for axle detection to alternatively consider just one of the two, as is to be inferred from the respective wording “maxima or instead minima”.

In the illustrated examples of FIGS. 2, 4 and 5, the adjacent measuring beams Bₙ overlap one another to such an extent that in each case at least the contact zone Zₙ of a radar sensor Rₙ falls up to or over the axle height (=radius) of the largest possible wheel 6 of an axle 4 to be detected. To this end, the measuring beams Bₙ in the illustrated examples have a beam width α according to:

$$α \geq 2 \cdot arc tan \frac{d}{e - {r}_{max}} \qquad ( equation 1 )$$

depending on the mutual distance d between adjacent transceivers Tₙ on the supporting structure 5, the height e of the transceivers Tₙ over the empty road 1 and the aforementioned radius rₘₐₓ of the largest possible wheel 6 of an axle 4 to be detected.

The mutual distance d between adjacent transceivers Tₙ on the supporting structure 5 may be constant over the width thereof, as illustrated in FIG. 2. Alternatively, the mutual distances d may also be different from one another, and therefore, for example in particularly interesting regions over the road 1, the transceivers Tₙ are arranged on the supporting structure 5 at a short mutual distance d and for example in edge regions of the road 1 with greater mutual distance d. Here, it is possible to adapt the beam width α according to equation 1; if desired, but also with different mutual distances d, all measuring beams Bₙ could have the same beam width α.

In the exemplary embodiment according to FIG. 5, the evaluation unit A, besides the width b of the vehicle 2 between the transceivers Tₙ, Tₙ₋ₓ of the radar sensors Rₙ, Rₙ₋ₓ (x=number of intermediate transceivers+1), also establishes the orientation β of the vehicle 2 on the road 1, more specifically from the time distance Δt and the maxima (or minima) v_{n,p} or v_{n-x,p} of the speed measurement values vₙ, vₙ₋ₓ of the two radar sensors Rₙ, Rₙ₋ₓ in the aforementioned tolerance time window W, from an established speed v_{F} of the vehicle 2 and from the established width b of the vehicle 2.

Here, the vehicle speed v_{F} can be detected conventionally by separate sensors (not illustrated), for example light barriers, radar sensors in the direction of travel of the road 1, etc., and can be provided to the evaluation unit A; alternatively, the evaluation unit A can also form the vehicle speed v_{F} itself from the maxima (or minima) v_{n,p}, v_{n-x,p} of the speed measurement values vₙ, vₙ₋ₓ generated by the radar sensors Rₙ, Rₙ₋ₓ, which, in the ideal case, as explained further above with regard to FIG. 1, correspond precisely to the vehicle speed V_{F}.

With the aid of the vehicle speed v_{F}, the evaluation unit A converts the time distance Δt into a physical distance of the wheels 6 on both sides of the vehicle 2 when passing by the device 3 and establishes from this and from the vehicle width b the orientation 13 of the vehicle on the road 1.

Furthermore, the evaluation unit A in the example of FIG. 5 establishes, from the position of the two aforementioned radar sensors Rₙ, Rₙ₋ₓ or transceivers Tₙ, Tₙ₋ₓ thereof on the supporting structure 5, the position of the vehicle 2 in the transverse direction of the road 1; and additionally estimates, from the established orientation β, the established position and the established speed v_{F} of the vehicle 2, a trajectory J of the vehicle 2 on the road 1.

The device 3 illustrated in FIG. 5 further comprises a first camera 9, which is directed onto a first road portion 1′ upstream of the device 3 and provides first recorded images I₁ to the evaluation unit A, and a second camera 10, which is directed onto a second road portion 1″ downstream of the device 3 and which provides second recorded images I₂ to the evaluation unit A. Here, the evaluation unit A according to this exemplary embodiment assigns a first recorded image I₁ of the vehicle 2 taken from the front to a second recorded image I₂ of the same vehicle 2 taken from the rear on the basis of the estimated trajectory J of the vehicle 2. The recorded images I₁, I₂ assigned to one another of a vehicle 2 can then be stored temporarily either in the device 3 or an independent memory of the computing unit C for subsequent readout or can be transmitted, for example via the communications connection 8, to a traffic monitoring central unit for further processing or use thereof.

Additionally, or alternatively to one of the two cameras 9, 10, the device 3 illustrated in FIG. 5 may also comprise at least one radio transceiver (not illustrated), which, optionally with the aid of a directional antenna, is directed onto the road 1 so as to read out identifying data via a radio link to a vehicle device (“onboard unit”, OBU) carried by a passing vehicle 2 from a memory thereof. In this case, the evaluation unit A assigns at least one of the recorded images I₁, I₂ of the vehicle 2 to the read-out identifying data of the vehicle device of the same vehicle 2, again on the basis of the estimated trajectory J of a vehicle 2, or, in the case of two recorded images I₁, I₂, assigns these two recorded images to one another, and stores the recorded image(s) I₁, I₂ and the read-out identifying data assigned thereto either in the device 3 or the memory of the computing unit C temporarily or transmits it/them to the traffic monitoring central unit or a toll central unit. On the one hand, a clear identifier for identifying the vehicle device and thus, as is conventional for example in toll systems, the vehicle or owner thereof, and/or on the other hand vehicle data such as dimensions, weight, axle number thereof, etc. constitute potential identifying data, which could be verified or at least checked for plausibility on the basis of the analysis of the evaluation unit A or the central unit; in the event of a deviation, the assigned recorded image(s) I₁, I₂ is/are used as proof.

### CONCLUSION

The disclosed subject matter is not limited to the presented embodiments, but includes all variants and modifications that fall within the scope of the accompanying claims. Thus, the specified tolerance time window W could also be variable and for example could be selected in a manner dependent on the established vehicle speed v_{F}.

What is claimed is:

1. A device for detecting an axle of a vehicle travelling on a road, comprising:
a plurality of radar sensors, which have radar transceivers distributed on a supporting structure transversely above the road and which each, by an approximately vertically downwardly directed radar measuring beam of the radar transceiver thereof, at successive moments in time generate a Doppler speed measurement value for an object reflecting the radar measuring beam, and
an evaluation unit, which is connected to measurement value outputs of the radar sensors and which is configured to detect an axle when two radar sensors generate, within a tolerance time window, maxima or minima of the speed measurement values thereof, said maxima or minima being of substantially identical size.

2. The device according to claim 1, wherein the evaluation unit is configured to only detect an axle when all radar sensors arranged between the two radar sensors generate for the same time speed measurement values which fall below a threshold value.

3. The device according to claim 1, further comprising:
a plurality of propagation time sensors, which have propagation time transceivers distributed on the supporting structure transversely above the road and which each, by an approximately vertically downwardly directed propagation time measuring beam of the propagation time transceiver thereof, at successive moments in time generate a propagation time distance measurement value for an object reflecting the propagation time measuring beam,
wherein the evaluation unit is also connected to measurement value outputs of the propagation time sensors and is configured to only detect an axle when all propagation time sensors arranged between the two radar sensors generate for the same time a distance measurement value corresponding to less than a height of said propagation time sensors above an empty road.

4. The device according to claim 1, comprising:
a plurality of propagation time sensors, which are each assigned to a radar sensor and which have propagation time transceivers distributed on the supporting structure transversely above the road and which each, by an approximately vertically downwardly directed propagation time measuring beam of the propagation time transceiver thereof, at successive moments in time generate a propagation time distance measurement value for an object reflecting the propagation time measuring beam,
wherein the evaluation unit is connected to measurement value outputs of the propagation time sensors and is configured to only detect an axle when the propagation time sensors assigned to the two radar sensors for the same time generate a distance measurement value corresponding to a height of said propagation time sensors above an empty road.

5. The device according to claim 3, wherein the propagation time sensors are formed by the radar sensors.

6. The device according to claim 1, wherein the evaluation unit is configured to establish a width of the vehicle from a mutual distance between the two radar sensors.

7. The device according to claim 6, wherein the evaluation unit is designed to establish an orientation of a vehicle on the road from a speed of said vehicle established from the maxima or minima, from the time distance between the two maxima or minima in the tolerance time window, and from the established width of said vehicle.

8. The device according to claim 1, wherein the evaluation unit is configured to establish a position of the vehicle in the transverse direction of the road from a position of the two radar sensors on the supporting structure.

9. The device according to claim 7, wherein the evaluation unit is configured to establish a position of the vehicle in the transverse direction of the road from a position of the two radar sensors on the supporting structure, and
wherein the evaluation unit is configured to estimate a trajectory of the vehicle on the road from the established orientation, the established position and the established speed of the vehicle.

10. The device according to claim 9, further comprising
a first camera, which is directed onto a first road portion upstream of the device and provides first recorded images to the evaluation unit, and
a second camera, which is directed onto a second road portion downstream of the device and provides second recorded images to the evaluation unit,
wherein the evaluation unit is designed to assign a first recorded image of a vehicle taken from the front to a second recorded image of the same vehicle taken from the rear on the basis of the estimated trajectory of said vehicle.

11. The device according to claim 9, comprising
at least one camera, which is directed onto a road portion upstream or downstream of the device and provides recorded images to the evaluation unit, and
a radio transceiver, which, in order to read out identifying data from a vehicle device carried by a passing vehicle, is directed onto the road and provides a read-out identifying data to the evaluation unit,
wherein the evaluation unit is configured to assign a recorded image of a vehicle to the read-out identifying data of the vehicle device of the same vehicle on the basis of the estimated trajectory of said vehicle.

12. A method for detecting an axle of a vehicle travelling on a road with the aid of a plurality of radar sensors, which have radar transceivers distributed on a supporting structure transversely above the road and which, by an approximately vertically downwardly directed radar measuring beam of the radar transceiver thereof, at successive moments in time generate a Doppler speed measurement value for an object reflecting the radar measuring beam, said method comprising:
detecting an axle when two radar sensors, within a tolerance time window, generate maxima or minima of the speed measurement values thereof, said maxima or minima being of substantially identical size.

13. The method according to claim 12, wherein the axle is only detected when, for the same time, all radar sensors arranged between the two radar sensors generate speed measurement values falling below a threshold value.

14. The method according to claim 12, carried out with the aid of a plurality of propagation time sensors, which have propagation time transceivers distributed on the supporting structure transversely above the road and which each, by an approximately vertically downwardly directed propagation time measuring beam of the propagation time transceivers thereof, at successive moments in time generate a propagation time distance measurement value for an object reflecting the propagation time measuring beam, wherein the axle is only detected when all propagation time sensors arranged between the two radar sensors for the same time generate a distance measurement value corresponding to less than a height of said propagation time sensors above an empty road.

15. The method according claim 12, carried out with the aid of a plurality of propagation time sensors, which are each assigned to a respective radar sensor and which have propagation time transceivers distributed on the supporting structure transversely the above the road and which each, by an approximately vertically downwardly directed propagation time measuring beam of the propagation time transceiver thereof, at successive moments in time generate a propagation time distance measurement value for an object reflecting the propagation time measuring beam, wherein the axle is only detected when the propagation time sensors assigned to the two radar sensors for the same time generate a distance measurement value corresponding to a height of said propagation time sensors above an empty road.

16. The method according to claim 12, wherein a width of the vehicle is established from a mutual distance between the two radar sensors, and in that an orientation of the vehicle on the road is established from a speed of said vehicle established from the maxima or minima, from the time distance of the two maxima or minima in the tolerance time window, and from the established width of the vehicle.

17. The method according to claim 12, wherein a position of the vehicle in the transverse direction of the road is established from a position of the two radar sensors on the supporting structure.

18. The method according to claim 16, wherein a position of the vehicle in the transverse direction of the road is established from a position of the two radar sensors on the supporting structure, and
wherein a trajectory of the vehicle on the road is estimated from the established orientation, the established position and the established speed of the vehicle, and in that, with the aid of a first camera, which is directed onto a first road portion upstream of the device and records first images, and a second camera, which is directed onto a second road portion downstream of the device and records second images, a first recorded image of the vehicle taken from the front is assigned to a second recorded image of the same vehicle taken from the rear on the basis of the estimated trajectory.
